(19) United States
(12) Patent Application Publication
(10) Pub. No.: US 2025/0050240 A1
(43) Pub. Date: Feb. 13, 2025

(54) SUPERCRITICAL FLUID EXTRACTION PROCESS WITH INTEGRATED PRESSURE EXCHANGER

(71) Applicant: James Khreibani, Miami Beach, FL (US)

(72) Inventor: James Khreibani, Miami Beach, FL (US)

(21) Appl. No.: 18/925,591

(22) Filed: Oct. 24, 2024

Related U.S. Application Data
(63) Continuation-in-part of application No. 17/592,449, filed on Feb. 3, 2022.

(51) Int. Cl. B01D 11/02; B01D 11/04

(52) U.S. Cl. CPC B01D 11/0203; B01D 11/028; B01D 11/0407; B01D 11/0488

(57) ABSTRACT

Processes and apparatuses for compound recovery using supercritical fluid (SCF) are disclosed. An example process involves solvent extraction (including hydrothermal liquefaction and gasification) of a extracted compound using a SCF from a solid or liquid substrate including, but not limited to, microalgae, plant matter, and polymers. The apparatus comprises SCF, an extraction vessel, a pressure exchanger, feedstock, a separate compound, and solid or liquid compound separators.

### CROSS-REFERENCE TO RELATED APPLICATIONS

This non-provisional patent application is a continuation-in-part of U.S. patent application Ser. No. 17/592,449, titled Supercritical Fluid Extraction Process With Integrated Pressure Exchanger, filed on Feb. 3, 202.

### FIELD OF THE INVENTION

The present invention relates to a process and apparatus for supercritical fluid (SCF) extraction including gasification and liquification conditions using pressure differentials and an integrated pressure exchanger.

### BACKGROUND OF THE INVENTION

Solvent extraction is a method to separate molecules and/or compounds based on their relative solubilities and properties. In typical supercritical fluid extraction processes, the SCF is heated and pressurized above the critical point to transform a sub-critical fluid into its supercritical phase. When the SCF makes contact with a solid or liquid substrate the target molecule and/or compound from within the solid or liquid substrate is extracted and, in some instances, converted into the desired molecule and/or compound. Throughout this specification, the terms molecule and compound are used interchangeably. However, for the sake of simplicity and consistency, the term compound will be used to refer to both molecules and compounds, unless otherwise specified. In the extraction processes, it is generally desirable to reuse the SCF. Thus, it is desirable to remove the target compound for extraction and the insoluble solid or liquid compound from the recycled SCF. In the case of microalgae, rapeseed, polymer, lithium and other forms of solid or liquid substrate. There is no commercial method for removing both the soluble compound and insoluble solid from the SCF while maintaining high pressure, supercritical or close to supercritical conditions in a closed-loop extraction process by adjusting the pressure alone. Known methods in the art involve cooling the reactor, depressurizing the reactor, or use additional absorption fluid or replenish solid or liquid substrate feedstock in batches. Such additional processing steps in conventional methods of SCF extraction result in an increased cycle time, excess energy consumption, and fatigue stress on the mechanical structure. It is known in the art that the use of a pressure exchanger, also known as an energy recovery device, is used in commercial desalination plants to transfer the energy from a high-pressure brine discharge into a low-pressure seawater intake similar to a turbocharger. Pressure exchangers are also commonly used as they make the process more cost-effective. However, common methods of supercritical fluid extraction do not use pressure exchangers.

In the context of chemical processing, supercritical gasification and supercritical liquefaction can be considered specialized forms of extraction, as both processes utilize the unique solvating properties of supercritical fluids to selectively extract valuable chemical constituents from feedstocks. In supercritical gasification, the fluid (typically water) acts as both a reaction medium and an extractant, breaking down and extracting volatile gases such as hydrogen and carbon monoxide from the feedstock through hydrolysis and oxidation under supercritical conditions. Similarly, in supercritical liquefaction, the process extracts liquid hydrocarbons by depolymerizing biomass and other polymeric materials into smaller organic molecules that dissolve into the supercritical phase, which enhances molecular mobility and solubility. Both processes share fundamental principles with conventional supercritical extraction by leveraging the phase behavior of supercritical fluids to separate targeted compounds, whether in supercritical, gas or liquid form, from complex matrices, thereby supporting their classification as specialized forms of extraction.

As further detailed by Belwal in “Recent advances in scaling-up of non-conventional extraction techniques: Learning from successes and failures”, there exists a need in the prior art for a process and apparatus for extracting a solute and other target materials using a SCF in a manner that eliminates the need to fully depressurize the process to extract spent insoluble compound and replenish the SCF. In addition, there is a need for a method and apparatus for high-efficiency solute removal from SCFs which is cost-efficient, reduces or eliminates waste streams, and minimizes the duration of downtime for cleaning, repair, and maintenance.

### SUMMARY OF THE INVENTION

The present invention relates to apparatus and processes for extracting a soluble or desired compound from a solid or liquid substrate while converting as much of the solid or liquid substrate into valuable compounds such as for example and without limitation hydrogen and methane. For example, and without limitation, the SCF extraction process disclosed herein may involve extracting one or more compounds from microalgae, hemp, canola, monomers, polymers and soybeans using a supercritical solvent such as H₂O, CO₂ or CH₃OH. The invention can also be used for the extraction, gasification, liquefaction and separation of two immiscible liquids. An example of SCF extraction system of the present disclosure comprises an extraction vessel and first compound and when specified a second compound separation vessels all acting substantially continuously within the supercritical phase or close to the supercritical phase. The use of a co-solvent such as ethanol, for example and without limitation is also within the scope of this invention.

For example and without limitation, a substantially pure SCF stream, at a sufficient pressure and temperature to support the process, fills the extraction vessel, first compound separation vessel, and second compound separation vessel, whereby supercritical conditions are achieved. The solid or liquid substrate is fed into the extraction vessel through a solid or liquid compound loading chamber or pipe that is mechanically coupled to the extraction vessel directly or indirectly. Generally, the loading chamber or pipe has pressure isolation valves installed, preventing the high extraction vessel pressure from escaping during loading and chamber clearing operations. The pressure boundary allows the solid or liquid compounds to continuously enter the extraction vessel without vessel depressurization.

Over a period of time, the SCF converts and extracts the solid or liquid substrate into the desired compound. The desired compound is then separated from the SCF by using one or a plurality of separation techniques, including, but not limited to, depressurization, cyclones, centrifuges, screens, or filters.

The present invention supports the use of solid particles and liquid substrate while generally maintaining a supercritical and near supercritical pressure and temperature that reduces expensive and time-consuming pressure and temperature cycles. In certain circumstances the use of a co-solvent such as ethanol or methanol, for example, in carbon dioxide or water may be used to accelerate the extraction process and remains within the scope of this invention.

### BRIEF DESCRIPTION OF THE DRAWINGS

The various embodiments of this disclosure will be better understood by referring to the following detailed description and the accompanying drawings which illustrate the disclosed configurations.

FIG. 1A to 1G show flow diagrams schematically illustrating the use of SCF, pressure, pressure exchanger, and separators to produce a separated extracted compound with the addition of compression devices to generate the conditions that enable SCF extraction. The reference numerals represent the following:

| | |
|---|---|
| 101 | high pressure feed stream |
| 102 | extraction vessel |
| 103 | extraction vessel discharge |
| 104 | pressure exchanger |
| 105 | pressure exchanger flow |
| 106 | first separation vessel |
| 107 | extracted compound |
| 108 | first separation vessel discharge |
| 109 | SCF recycle flow |
| 110 | low pressure feed stream |
| 111 | feed pressurization device |
| 112 | SCF recycle pressurization device |
| 113 | repressurized SCF recycle |
| 114 | ejector |
| 115 | ejector motive flow stream |
| 116 | second extracted compound |
| 117 | insoluble separator device |
| 118 | insoluble separator discharge flow |
| 119 | insoluble reject flow |

FIG. 2A to 2F show flow diagrams schematically illustrating the use of SCF, pressure, pressure exchanger, and separators to produce a separated extracted compound with the addition of compression devices to generate the conditions that enable SCF extraction. The reference numerals represent the following:

| | |
|---|---|
| 201 | high pressure feed stream |
| 202 | extraction vessel |
| 203 | extraction vessel flow |
| 204 | pressure exchanger |
| 205 | pressure exchanger discharge flow |
| 206 | first separation vessel |
| 207 | extracted compound |
| 208 | first separation vessel discharge |
| 209 | second pressure exchanger |
| 210 | second pressure exchanger discharge flow |
| 211 | second separation vessel |
| 212 | second extracted compound |
| 213 | second separation vessel discharge |
| 214 | Second SCF recycle flow |
| 215 | SCF recycle flow |
| 216 | low pressure feed stream |
| 217 | feed pressurization device |
| 218 | SCF recycle pressurization device |
| 219 | repressurized SCF recycle flow |
| 220 | ejector |
| 221 | ejector motive flow stream |
| 222 | second extracted compound |
| 223 | insoluble separator device |
| 224 | insoluble separator discharge flow |
| 225 | insoluble reject flow |

FIG. 3A to 3G show flow diagrams schematically illustrating the use of SCF, pressure, separators to produce a separated extracted compound with the addition of compression devices and decompression devices to generate the conditions that enable SCF extraction. The reference numerals represent the following:

| | |
|---|---|
| 301 | high pressure feed stream |
| 302 | extraction vessel |
| 303 | extraction vessel discharge |
| 304 | decompression device |
| 304B | mechanical shaft/electrical cable |
| 304C | compression device |
| 305 | pressure exchanger flow |
| 306 | first separation vessel |
| 307 | extracted compound |
| 308 | first separation vessel discharge |
| 309 | SCF recycle flow |
| 310 | low pressure feed stream |
| 311 | feed pressurization device |
| 312 | SCF recycle pressurization device |
| 313 | repressurized SCF recycle |
| 314 | ejector |
| 315 | ejector motive flow stream |
| 316 | second extracted compound |
| 317 | insoluble separator device |
| 318 | insoluble separator discharge flow |
| 319 | insoluble reject flow |

### DETAILED DESCRIPTION OF THE INVENTION

Any substance above its critical temperature and pressure experiences a phase change into a SCF and exhibits properties between those of gases and liquids. Unlike gases, SCFs possess considerable solvent strength, and their transport properties are more favorable than liquid solvents due to their lower viscosity and increased diffusion coefficients. The density and solvent strength of the SCF may be modified over a modest range with small variations in temperature and pressure. This tunability may be used to control the behavior, separation process, extraction rates, and to specifically select which chemicals to extract and convert including the composition of gasified and liquefaction compounds.

The disclosure relates to apparatuses and processes for the extraction and conversion from a solid or liquid compound. However, for the sake of simplicity and consistency, the term extraction will refer also comply conversion, abstraction, scission, or any other means of obtaining a compound from the process that differs in any way from the original soluble or insoluble substrate feedstock. For example, and without limitation, techniques described herein may involve extracting soluble compounds from substrates such as canola, hemp, polymer, lithium, lignocellulosic biomass and microalgae using a SCF a solvent, catalyst and reactive medium. For example, and without limitation, H₂O and CO₂ and may be used for SCF extraction due to its ability to perform SCF extraction at a relatively low pressure and temperature, and due to its abundance as a non-toxic natural substance. When for example and without limitation, a co-solvent such as ethanol is used to accelerate the extraction process is also within the scope of this invention.

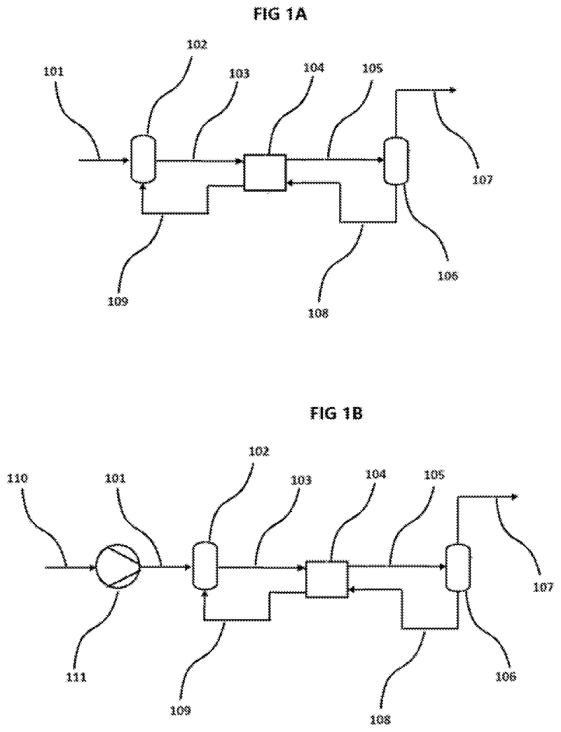

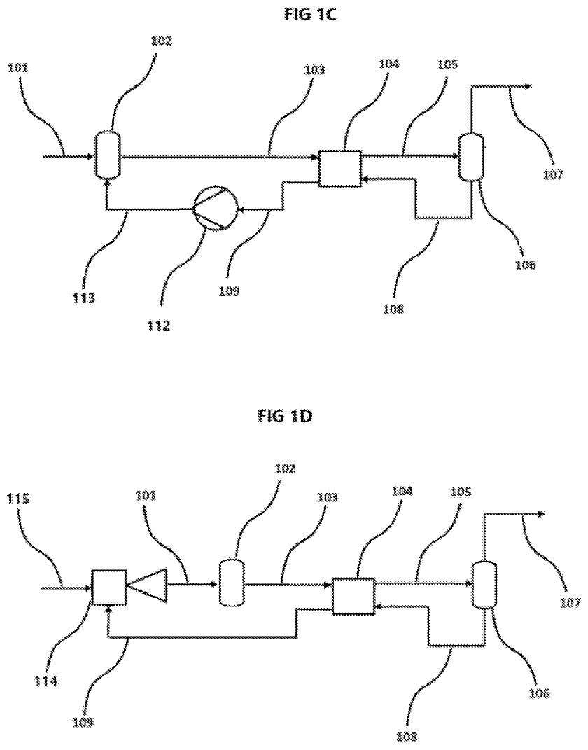

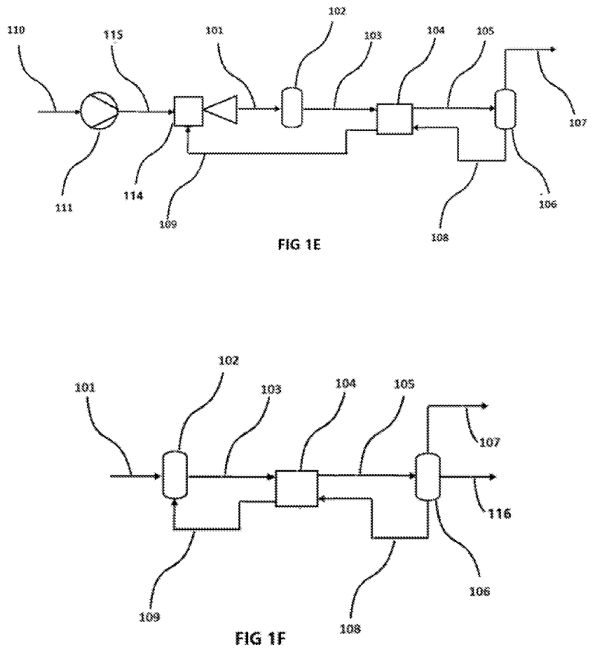

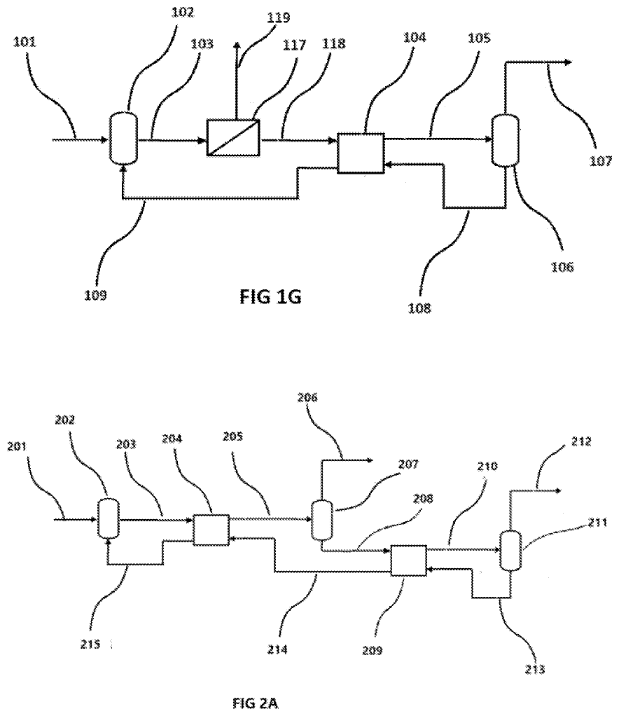

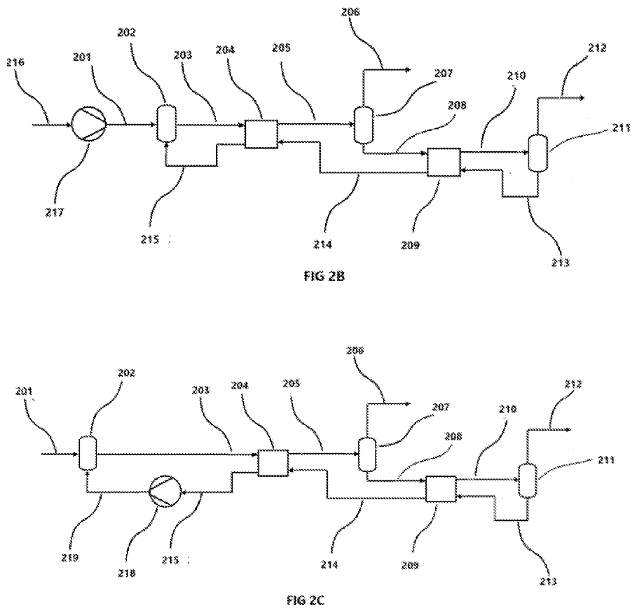

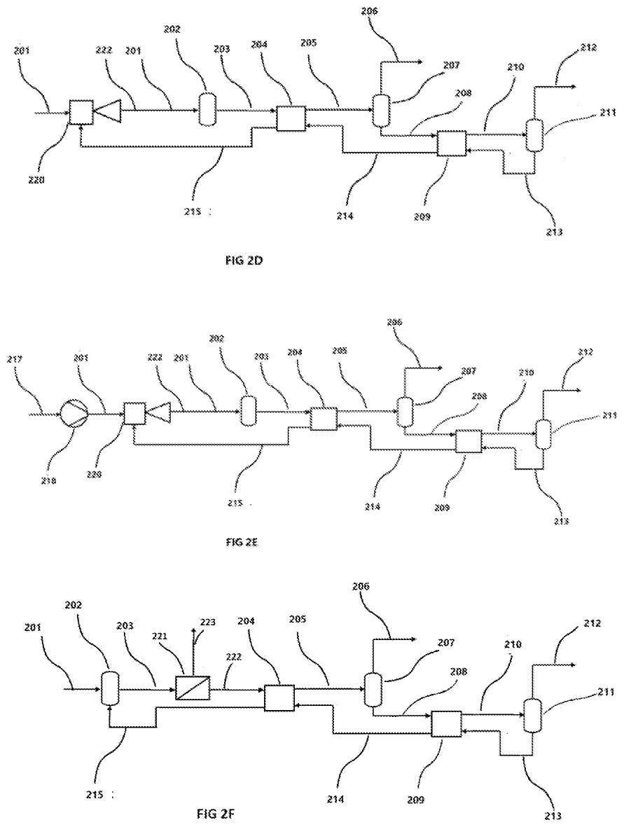

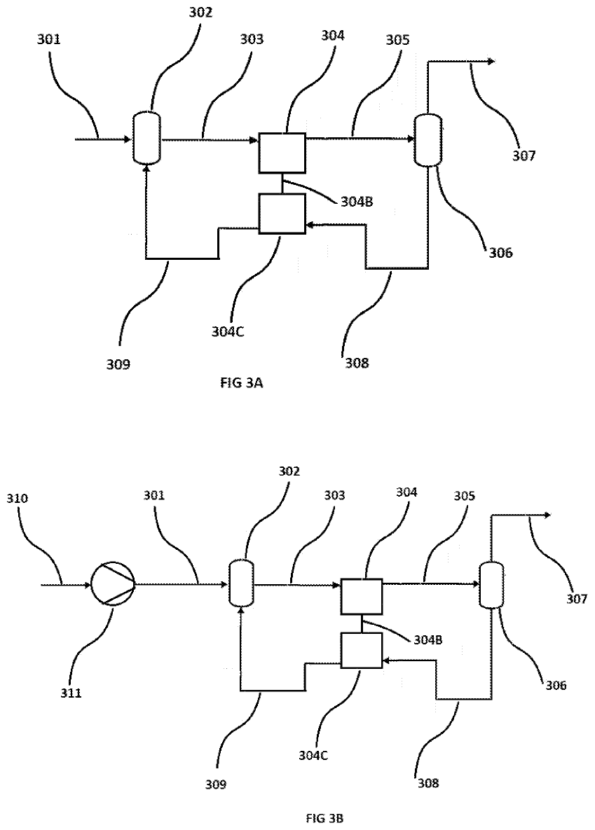

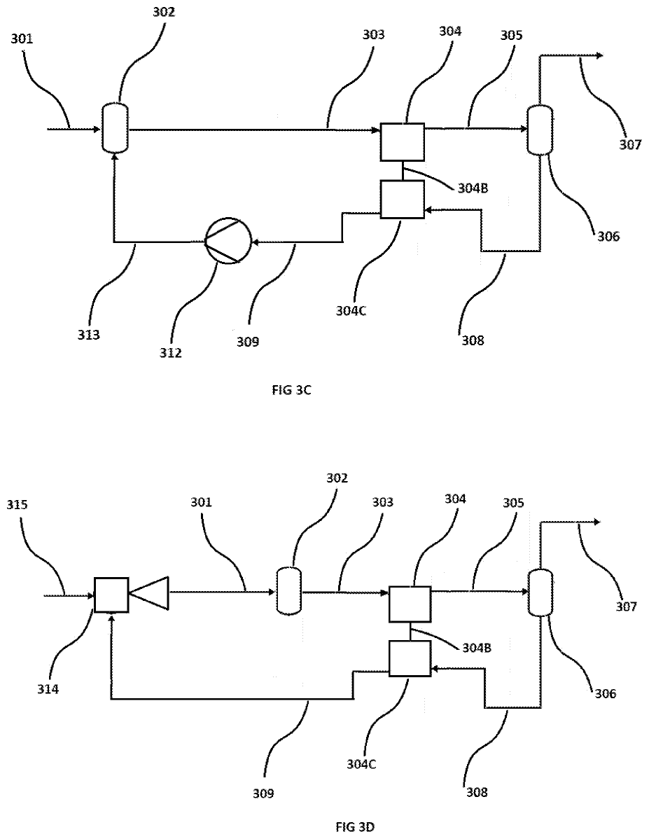

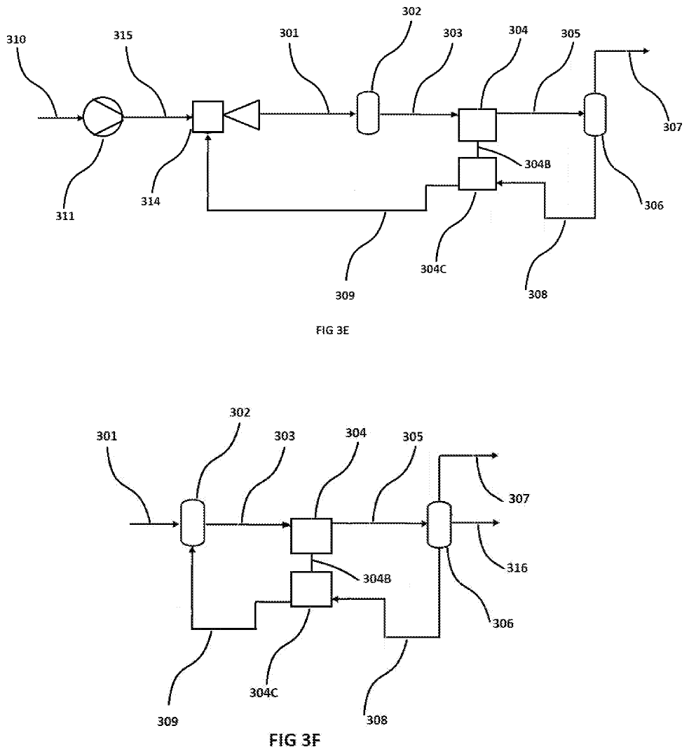

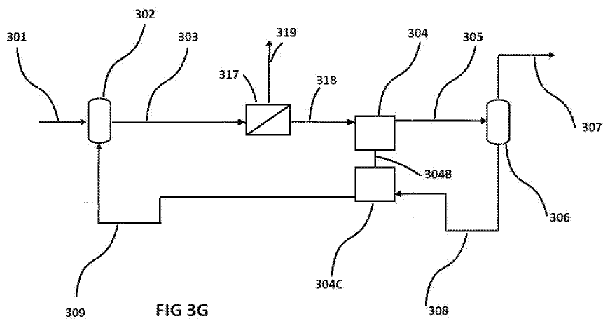

More specifically, one embodiment of this disclosure is shown in FIG. 1A whereby a high pressure feed stream 101 or plurality of high pressure feed streams 101 that comprises the solid or liquid substrate that will be the feedstock for the process enters an extraction vessel 102. The extraction vessel 102 has generally been prefilled with contains SCF. The high pressure feed stream 101 contents may be substantially pure solid or liquid substrate that will be extracted or may be mixed with another fluid, such as the same fluid as the SCF to improve the flow of the high pressure feed stream 101 into the extraction vessel 102. After a period of time which is dependent on the specific SCF, the particular solid or liquid substrate used, and the process conditions, the target compound or plurality of target compounds will be extracted from the solid or liquid substrate into the SCF solvent (not shown) leaving a substantially insoluble compound, that may be a solid or liquid (not shown). Depending on the solid or liquid substrate (not shown) and the SCF solvent (not shown) the substantially insoluble compound which may be ash, tar, salts or another compound can range from less than 1% to over 50% of the solid or liquid substrate.

The extracted compound, or plurality of extracted compounds and SCF solvent mixture is conveyed through a pipe as extraction flow 103 from the extraction vessel 102, to the pressure exchanger 104. The extracted compound may be any compound but by way of example and without limitation may be H₂, CO₂, CO, CH₄, Alkanes, Alkenes, Alkynes, other or any combination thereof. The pipe that conveys the extraction flow 103 is mechanically coupled to the extraction vessel 102 at the inlet and mechanically coupled to the pressure exchanger 104 at the discharge. The extraction flow 103 is conveyed through the pressure exchanger 104 and is discharged at a lower pressure as pressure exchanger discharge flow 105. The reduction in pressure between the extraction flow 103 and the pressure exchanger discharge flow 105, induced by the pressure exchanger 104, may alter the density, miscibility, solvent strength, and other properties of the SCF in the pressure exchanger discharge flow 105. These changes facilitate the separation of the extraction compound from the SCF within the pressure exchanger discharge flow 105. The pressure exchanger discharge flow 105 is conveyed by pipe that is mechanically coupled to the pressure exchanger 104 at the inlet and mechanically coupled to the first separation vessel 106 at the discharge. The pressure exchanger discharge flow 105 may enter the first separation vessel 106 for example, and without limitation, directly through a nozzle (not shown) in the first separation vessel 106 wall. Alternatively the first separation vessel 106 may be combined and mechanically coupled to, for example, and without limitation, a hydro-cyclone (not shown), centrifuge (not shown), coalescer (not shown), filter (not shown), internal trays (not shown), another compound separator (not shown), or a combination thereof and is known in the art to support the separation of the extracted compound 107 that is mixed within the extraction flow 103 from the SCF. As the pressure exchanger discharge flow 105 is conveyed through the first separation vessel 106 the extracted compound 107 is separated from the pressure exchanger discharge flow 105 and discharged from the first separation vessel 106. The remaining components of the pressure exchanger discharge flow 105 which predominantly comprises SCF is discharged from the first separation vessel 106 as first separation vessel discharge 108 and conveyed by pipe to the pressure exchanger 104. The pipe used to convey the first separation vessel discharge 108 is mechanically coupled to the first separation vessel 106 at the inlet and mechanically coupled to the pressure exchanger 104 at the discharge. The first separation vessel discharge 108 is conveyed through the pressure exchanger 104 and is discharged at a higher pressure as SCF recycle flow 109. The increase in pressure between the first separation vessel discharge 108 and the SCF recycle flow 109, induced by the pressure exchanger 104, increases the pressure to allow the extraction process to continue saving valuable lost energy that ordinarily would occur in existing SCF processes. The SCF recycle flow 109 is conveyed through pipe back to the extraction vessel 102. The pipe that conveys the SCF recycle flow 109 is mechanically coupled to the pressure exchanger 104 at the inlet and mechanically coupled to the extraction vessel 102 at the discharge. When the SCF recycle flow 109 enters the extraction vessel 102 it makes contact again with the high pressure feed stream 101 where the cycle described in this embodiment of the invention is repeated.

In another embodiment of the present invention and shown in FIG. 1B a low pressure feed stream 110 or plurality of low pressure feed stream 110 that comprises the solid or liquid substrate enters a feed pressurization device 111, which increases the pressure of low pressure feed stream 110 to an amount required for the specific solid or liquid substrate and SCF combination used in the process. The feed pressurization device 111 discharges the high pressure feed stream 101 which is conveyed by pipe into the extraction vessel 102. The remaining components are identical to those described in the previous embodiment shown in FIG. 1A. The feed pressurization device 111 is any device that can increase the pressure of the low pressure feed stream 110, which may include a compressor, a pump, screw press, an ejector, another compression device, or a combination thereof, provides sufficient pressure to enable the process to be performed.

In another embodiment of the present invention and shown in FIG IC the SCF recycle flow 109 is discharged from the pressure exchanger 104 and conveyed through pipe to the SCF recycle pressurization device 112 where the pressure of the SCF recycle flow 109 is increased and allow for any losses in the system to be regained. The SCF recycle pressurization device 112 discharges repressurized SCF recycle flow 113 which is conveyed through pipe mechanically coupled to the SCF recycle pressurization device 112 at the inlet and mechanically coupled to the extraction vessel 102 at the discharge. The remaining components are identical to those described in the previous embodiment shown in FIG. 1A. The SCF recycle pressurization device 112 is any device that can increase the pressure of the SCF recycle flow 109, which may include a compressor, a pump, screw press, an ejector, another compression device, or a combination thereof, provides sufficient pressure to enable the process to be performed.

In another embodiment of the present invention and shown in FIG. 1D the SCF recycle flow 109 is discharged from the pressure exchanger 104 and conveyed through pipe to the ejector 114 or plurality of ejectors 114. The ejector motive flow stream 115 or plurality of ejector motive flow stream 115 that comprises the solid or liquid substrate enters an ejector 114 and provides the driving force for the ejector 114 to entrain the SCF recycle flow 109 using methods well known in the art. The ejector 114 discharges the high-pressure feed stream 101 which is conveyed by pipe into the extraction vessel 102. The pipe that conveys the high-pressure feed stream 101 is mechanically coupled to the ejector 114 at the inlet and mechanically coupled to the extraction vessel 102 at the discharge. The remaining components are identical to those described in the previous embodiment shown in FIG. 1A.

In another embodiment of the present invention and shown in FIG. 1E the SCF recycle flow 109 is discharged from the pressure exchanger 104 and conveyed through pipe to the ejector 114 or plurality of ejectors 114. A low pressure feed stream 110 or plurality of low pressure feed stream 110 that comprises the solid or liquid substrate enters a feed pressurization device 111, which increases the pressure of low pressure feed stream 110 to an amount required for the specific solid or liquid substrate and SCF combination used in the process. The feed pressurization device 111 the ejector motive flow stream 115 or plurality of ejector motive flow stream 115 that comprises the solid or liquid substrate enters an ejector 114 and provides the driving force for the ejector 114 to entrain the SCF recycle flow 109 using methods well known in the art. The remaining components are identical to those described in the previous embodiment shown in FIG. 1D.

In another embodiment of the present invention and shown in FIG IF the pressure exchanger discharge flow 105 is conveyed through the first separation vessel 106 and the extracted compound 107 is separated from the pressure exchanger discharge flow 105 and discharged from the first separation vessel 106. A second extracted compound 116 that may have a higher density or larger molecular size for example and without limitation than the extracted compound 107 is also separated from the pressure exchanger discharge flow 105 and the extracted compound 107 and discharged from the first separation vessel 106. The inclusion of trays, filters and other methods well known in the art may be installed within the first separation vessel 106 to induce the separation between extracted compound 107, second extracted compound 116 and SCF. The remaining components of the pressure exchanger discharge flow 105 which predominantly comprise SCF is discharged from the first separation vessel 106 as first separation vessel discharge 108 and conveyed through pipe to the pressure exchanger 104. The remaining components are identical to those described in the previous embodiment shown in FIG. 1A.

In another embodiment of the present invention and shown in FIG. 1G the extraction flow 103 is discharged from the extraction vessel 102 and conveyed through pipe to the mechanically coupled insoluble separator device 117. The insoluble separator device 117 is known in the art and may be for example and without limitation a mechanical filter, cyclone, hydro cyclone, coalescing filter, membrane filter, centrifuge strainer or any other device that can separate the insoluble compounds from the extraction flow 103 while retaining the pressure of the extraction flow 103. As the extraction flow 103 is conveyed through the insoluble separator device 117 the insoluble compounds (not shown) are removed from the extraction flow 103 where by the extraction flow 103 is discharged from the insoluble separator device 117 substantially removed of insoluble compounds (not shown) and conveyed by a mechanically coupled pipe as insoluble separator discharge flow 118 to the pressure exchanger 104. The retained insoluble compounds are discharged from the insoluble separator device 117 as insoluble reject flow 119. The remaining components are identical to those described in the previous embodiment shown in FIG. 1A.

In another embodiment of the present invention is shown in FIG. 2A whereby a high pressure feed stream 201 or plurality of high pressure feed streams 201 that comprises the solid or liquid substrate that will be the feedstock for the process enters an extraction vessel 202. The extraction vessel 201 already contains SCF. The high pressure feed stream 201 contents may be substantially pure solid or liquid substrate that will be extracted or may be mixed with another fluid to improve the flow of the high pressure feed stream 201 into the extraction vessel 202. After a period of time which is dependent on the specific SCF, the particular solid or liquid substrate used, and the process conditions, the target compound or plurality of target compounds will be extracted from the solid or liquid substrate into the SCF solvent (not shown) leaving a substantially insoluble compound, that may be a solid or liquid (not shown). Depending on the solid or liquid substrate (not shown) and the SCF solvent (not shown) the substantially insoluble compound which may be ash, tar, salts or another compound can range from less than 1% to over 50% of the solid or liquid substrate.

The extracted compound, or plurality of extracted compounds, insoluble compound and SCF solvent mixture is conveyed through a pipe as extraction flow 203 from the extraction vessel 202, to the pressure exchanger 204. The extracted compound may be any compound but by way of example and without limitation may be H2, CO2, CO, CH4, Alkanes, Alkenes, Alkynes, other or any combination thereof. The pipe that conveys the extraction flow 203 is mechanically coupled to the extraction vessel 202 at the inlet and mechanically coupled to the pressure exchanger 204 at the discharge. The extraction flow 203 is conveyed through the pressure exchanger 204 and is discharged at a lower pressure as pressure exchanger discharge flow 205. The reduction in pressure between the extraction flow 203 and the pressure exchanger discharge flow 205, induced by the pressure exchanger 204, may alter the density, miscibility, solvent strength, and other properties of the SCF in the pressure exchanger discharge flow 205. These changes facilitate the separation of the extraction compound from the SCF within the pressure exchanger discharge flow 205. The pressure exchanger discharge flow 205 is conveyed by pipe that is mechanically coupled to the pressure exchanger 204 at the inlet and mechanically coupled to the first separation vessel 206 at the discharge. The pressure exchanger discharge flow 205 may enter the first separation vessel 206 for example, and without limitation, directly through a nozzle (not shown) in the first separation vessel 206 wall. Alternatively the first separation vessel 206 may be combined and mechanically coupled to for example, and without limitation, a hydro-cyclone (not shown), centrifuge (not shown), coalescer (not shown), filter (not shown), internal trays (not shown), another compound separator (not shown), or a combination thereof is known in the art and separates the extracted compound 207 that is mixed within the extraction flow 203 from the SCF. As the pressure exchanger discharge flow 205 is conveyed through the first separation vessel 206 the extracted compound 207 is separated from the pressure exchanger discharge flow 205 and discharged from the first separation vessel 206. The remaining components of the pressure exchanger discharge flow 205 which is substantially removed of the extracted compound 207 and comprises SCF is discharged from the first separation vessel 206 as first separation vessel discharge 208 and conveyed by pipe to the second pressure exchanger 209. The pipe used to convey the first separation vessel discharge 208 is mechanically coupled to the first separation vessel 206 at the inlet and mechanically coupled to the second pressure exchanger 209 at the discharge. The first separation vessel discharge 208 is conveyed through the second pressure exchanger 209 and is discharged at a lower pressure as second pressure exchanger discharge flow 210. The reduction in pressure between the first separation vessel discharge 208 and the second pressure exchanger discharge flow 210, induced by the second pressure exchanger 209, may alter the density, miscibility, solvent strength, and other properties of the SCF in the second pressure exchanger discharge flow 210. These changes facilitate the separation of the remaining extraction compound from the SCF within the second pressure exchanger discharge flow 210. The pressure exchanger discharge flow 205 is conveyed by pipe that is mechanically coupled to the second pressure exchanger 209 at the inlet and mechanically coupled to the second separation vessel 211 at the discharge. The second pressure exchanger discharge flow 210 may enter the second separation vessel 211 for example, and without limitation, directly through a nozzle (not shown) in the second separation vessel 211 wall. Alternatively the second separation vessel 211 may be combined and mechanically coupled to for example, and without limitation, a hydro-cyclone (not shown), centrifuge (not shown), coalescer (not shown), filter (not shown), internal trays (not shown), another compound separator (not shown), or a combination thereof is known in the art and separates the second extracted compound 212 that is mixed within the second pressure exchanger discharge flow 210 from the SCF. As the second pressure exchanger discharge flow 210 is conveyed through the second separation vessel 211 the second extracted compound 212 is separated from the second pressure exchanger discharge flow 210 and discharged from the second separation vessel 211. The remaining components of the second pressure exchanger discharge flow 210 which is substantially removed of the extracted compound 207 and second extracted compound 212 and substantially comprises SCF is discharged from the second separation vessel 211 as second separation vessel discharge 213 and conveyed by pipe to the second pressure exchanger 209. The pipe used to convey the second separation vessel discharge 213 is mechanically coupled to the second separation vessel 211 at the inlet and mechanically coupled to the second pressure exchanger 209 at the discharge. The second separation vessel discharge 213 is conveyed through the second pressure exchanger 209 and is discharged at a higher pressure as second SCF recycle flow 214. The increase in pressure between the second separation vessel discharge 213 and the second SCF recycle flow 214, induced by the second pressure exchanger 209, increases the pressure to allow the extraction process to continue saving valuable lost energy that ordinarily would occur in existing SCF processes. The second SCF recycle flow 214 is conveyed through pipe back to the pressure exchanger 204. The second SCF recycle flow 214 is conveyed through the pressure exchanger 204 and is discharged at a higher pressure as SCF recycle flow 215. The increase in pressure between the second SCF recycle flow 214 and the SCF recycle flow 215, induced by the pressure exchanger 204, increases the pressure to allow the extraction process to continue saving valuable lost energy that ordinarily would occur in existing SCF processes. The SCF recycle flow 215 is conveyed through pipe to the extraction vessel 202. The pipe that conveys the SCF recycle flow 215 is mechanically coupled to the pressure exchanger 204 at the inlet and mechanically coupled to the extraction vessel 202 at the discharge. When the SCF recycle flow 215 enters the extraction vessel 202 it makes contact again with the high pressure feed stream 201 where the cycle described in this embodiment of the invention is repeated.

In another embodiment of the present invention and shown in FIG. 2B a low pressure feed stream 216 or plurality of low pressure feed stream 216 that comprises the solid or liquid substrate enters a feed pressurization device 217, which increases the pressure of low pressure feed stream 216 to an amount required for the specific solid or liquid substrate and SCF combination used in the process. The feed pressurization device 217 discharges the high pressure feed stream 201 which is conveyed by pipe into the extraction vessel 202. The remaining components are identical to those described in the previous embodiment shown in FIG. 2A. The feed pressurization device 217 is any device that can increase the pressure of the low pressure feed stream 216, which may include a compressor, a pump, screw press, an ejector, another compression device, or a combination thereof, provides sufficient pressure to enable the process to be performed.

In another embodiment of the present invention and shown in FIG. 2C the SCF recycle flow 215 is discharged from the pressure exchanger 204 and conveyed through pipe to the SCF recycle pressurization device 218 where the pressure of the SCF recycle flow 215 is increased and allow for any losses in the system to be regained. The SCF recycle pressurization device 218 discharges repressurized SCF recycle flow 219 which is conveyed through pipe mechanically coupled to the SCF recycle pressurization device 218 at the inlet and mechanically coupled to the extraction vessel 202 at the discharge. The remaining components are identical to those described in the previous embodiment shown in FIG. 2A. The SCF recycle pressurization device 218 is any device that can increase the pressure of the SCF recycle flow 215, which may include a compressor, a pump, screw press, an ejector, another compression device, or a combination thereof, provides sufficient pressure to enable the process to be performed.

In another embodiment of the present invention and shown in FIG. 2D the SCF recycle flow 215 is discharged from the pressure exchanger 204 and conveyed through pipe to the ejector 220 or plurality of ejectors 220. The ejector motive flow stream 221 or plurality of ejector motive flow stream 221 that comprises the solid or liquid substrate enters an ejector 220 and provides the driving force for the ejector 220 to entrain the SCF recycle flow 215 using methods well known in the art. The ejector 220 discharges the high-pressure feed stream 201 which is conveyed by pipe into the extraction vessel 202. The pipe that conveys the high-pressure feed stream 201 is mechanically coupled to the ejector 220 at the inlet and mechanically coupled to the extraction vessel 202 at the discharge. The remaining components are identical to those described in the previous embodiment shown in FIG. 2A.

In another embodiment of the present invention and shown in FIG. 2E the SCF recycle flow 215 is discharged from the pressure exchanger 204 and conveyed through pipe to the ejector 220 or plurality of ejectors 220. A low pressure feed stream 216 or plurality of low pressure feed stream 216 that comprises the solid or liquid substrate enters a feed pressurization device 217, which increases the pressure of low pressure feed stream 216 to an amount required for the specific solid or liquid substrate and SCF combination used in the process. The feed pressurization device 217 the ejector motive flow stream 220 or plurality of ejector motive flow stream 220 that comprises the solid or liquid substrate enters an ejector 220 and provides the driving force for the ejector 220 to entrain the SCF recycle flow 215 using methods well known in the art. The remaining components are identical to those described in the previous embodiment shown in FIG. 2D.

In another embodiment of the present invention and shown in FIG. 1G the extraction flow 203 is discharged from the extraction vessel 202 and conveyed through pipe to the mechanically coupled insoluble separator device 221. The insoluble separator device 221 is known in the art and may be for example and without limitation a mechanical filter, cyclone, hydro cyclone, coalescing filter, membrane filter, centrifuge strainer or any other device that can separate the insoluble compounds from the extraction flow 203 while retaining the pressure of the extraction flow 203. As the extraction flow 203 is conveyed through the insoluble separator device 221 the insoluble compounds (not shown) are removed from the extraction flow 203 where by the extraction flow 203 is discharged from the insoluble separator device 221 substantially removed of insoluble compounds (not shown) and conveyed by a mechanically coupled pipe as insoluble separator discharge flow 222 to the pressure exchanger 204. The retained insoluble compounds are discharged from the insoluble separator device 221 as insoluble reject flow 223. The remaining components are identical to those described in the previous embodiment shown in FIG. 2A.

In another embodiment of the present invention is shown in FIG. 3A whereby a high pressure feed stream 301 or plurality of high pressure feed streams 301 that comprises the solid or liquid substrate enters an extraction vessel 302, which contains SCF. The high pressure feed stream 301 contents may be substantially pure solid or liquid substrate that will be extracted or may be mixed with another fluid to improve the flow of the high pressure feed stream 301 into the extraction vessel 302. After a period of time which is dependent on the specific SCF, the particular solid or liquid substrate used, and the process conditions, the soluble compound will be extracted from the solid or liquid substrate into the SCF solvent (not shown) leaving a substantially insoluble compound, that may be a solid or liquid (not shown). Depending on the solid or liquid substrate (not shown) and the SCF solvent (not shown) the substantially insoluble compound which may be ash, tar, salts or another compound can range from less than 1% to over 50% of the solid or liquid substrate.

The extracted compound, or plurality of extracted compounds and SCF solvent mixture is conveyed through a pipe as extraction flow 303 from the extraction vessel 302, to the decompression device 304. The decompression device 304 may for example and without limitation be a turbine, turbocharger or other device that takes a high pressure at the inlet and reduces the pressure at the outlet using methods known in the art. The energy that is lost across the decompression device 304 may be transferred for example and without limitation a mechanically coupled mechanical shaft/electrical cable 304B that is mechanically coupled at the other end to drive a compression device 304C. The extracted compound may be any compound but by way of example and without limitation may be H₂, CO₂, CO, CH₄, Alkanes, Alkenes, Alkynes, other or any combination thereof. The pipe that conveys the extraction flow 303 is mechanically coupled to the extraction vessel 302 at the inlet and mechanically coupled to the decompression device 304 at the discharge. The extraction flow 303 is conveyed through the decompression device 304 and is discharged at a lower pressure as pressure exchanger discharge flow 305. The reduction in pressure between the extraction flow 303 and the pressure exchanger discharge flow 305, induced by the decompression device 304, may alter the density, miscibility, solvent strength, and other properties of the SCF in the pressure exchanger discharge flow 305. These changes facilitate the separation of the extraction compound from the SCF within the pressure exchanger discharge flow 305. The pressure exchanger discharge flow 305 is conveyed by pipe that is mechanically coupled to the decompression device 304 at the inlet and mechanically coupled to the first separation vessel 306 at the discharge. The pressure exchanger discharge flow 305 may enter the first separation vessel 306 for example, and without limitation, directly through a nozzle (not shown) in the first separation vessel 306 wall. Alternatively the first separation vessel 306 may be combined and mechanically coupled to for example, and without limitation, a hydro-cyclone (not shown), centrifuge (not shown), coalescer (not shown), filter (not shown), internal trays (not shown), another compound separator (not shown), or a combination thereof is known in the art and separates the extracted compound 307 that is mixed within the extraction flow 303 from the SCF. As the pressure exchanger discharge flow 305 is conveyed through the first separation vessel 306 the extracted compound 307 is separated from the pressure exchanger discharge flow 305 and discharged from the first separation vessel 306. The remaining components of the pressure exchanger discharge flow 305 which predominantly comprises SCF is discharged from the first separation vessel 306 as first separation vessel discharge 308 and conveyed by pipe to the compression device 304C. The compression device 304C which may include for example and without limitation a pump, compressor, a rotor or other means of compressing flow into a higher pressure then that received at the compression device 304C inlet. The pipe used to convey the first separation vessel discharge 308 is mechanically coupled to the first separation vessel 306 at the inlet and mechanically coupled to the compression device 304C at the discharge. The first separation vessel discharge 308 is conveyed through the compression device 304C and is discharged at a higher pressure as SCF recycle flow 309. The increase in pressure between the first separation vessel discharge 308 and the SCF recycle flow 309, induced by the pressure exchanger 304, increases the pressure to allow the extraction process to continue saving valuable lost energy that ordinarily would occur in existing SCF processes. The SCF recycle flow 309 is conveyed through pipe back to the extraction vessel 302. The pipe that conveys the SCF recycle flow 309 is mechanically coupled to the compression device 304C at the inlet and mechanically coupled to the extraction vessel 302 at the discharge. When the SCF recycle flow 309 enters the extraction vessel 302 it makes contact again with the high pressure feed stream 301 where the cycle described in this embodiment of the invention is repeated.

In another embodiment of the present invention and shown in FIG. 3B a low pressure feed stream 310 or plurality of low pressure feed stream 310 that comprises the solid or liquid substrate enters a feed pressurization device 311, which increases the pressure of low pressure feed stream 310 to an amount required for the specific solid or liquid substrate and SCF combination used in the process. The feed pressurization device 311 discharges the high pressure feed stream 301 which is conveyed by pipe into the extraction vessel 302. The remaining components are identical to those described in the previous embodiment shown in FIG. 3A. The feed pressurization device 311 is any device that can increase the pressure of the low pressure feed stream 310, which may include a compressor, a pump, screw press, an ejector, another compression device, or a combination thereof, provides sufficient pressure to enable the process to be performed.

In another embodiment of the present invention and shown in FIG. 3C the SCF recycle flow 309 is discharged from the compression device 304C and conveyed through pipe to the SCF recycle pressurization device 312 where the pressure of the SCF recycle flow 309 is increased and allow for any losses in the system to be regained. The SCF recycle pressurization device 312 discharges repressurized SCF recycle flow 313 which is conveyed through pipe mechanically coupled to the SCF recycle pressurization device 312 at the inlet and mechanically coupled to the extraction vessel 302 at the discharge. The remaining components are identical to those described in the previous embodiment shown in FIG. 3A. The SCF recycle pressurization device 312 is any device that can increase the pressure of the SCF recycle flow 309, which may include a compressor, a pump, screw press, an ejector, another compression device, or a combination thereof, provides sufficient pressure to enable the process to be performed.

In another embodiment of the present invention and shown in FIG. 3D the SCF recycle flow 309 is discharged from the compression device 304C and conveyed through pipe to the ejector 314 or plurality of ejectors 314. The ejector motive flow stream 315 or plurality of ejector motive flow stream 315 that comprises the solid or liquid substrate enters an ejector 314 and provides the driving force for the ejector 314 to entrain the SCF recycle flow 309 using methods well known in the art. The ejector 314 discharges the high-pressure feed stream 301 which is conveyed by pipe into the extraction vessel 302. The pipe that conveys the high-pressure feed stream 301 is mechanically coupled to the ejector 314 at the inlet and mechanically coupled to the extraction vessel 302 at the discharge. The remaining components are identical to those described in the previous embodiment shown in FIG. 3A.

In another embodiment of the present invention and shown in FIG. 3E the SCF recycle flow 309 is discharged from the compression device 304C and conveyed through pipe to the ejector 314 or plurality of ejectors 314. A low pressure feed stream 310 or plurality of low pressure feed stream 310 that comprises the solid or liquid substrate enters a feed pressurization device 311, which increases the pressure of low pressure feed stream 310 to an amount required for the specific solid or liquid substrate and SCF combination used in the process. The feed pressurization device 311 the ejector motive flow stream 315 or plurality of ejector motive flow stream 315 that comprises the solid or liquid substrate enters an ejector 314 and provides the driving force for the ejector 314 to entrain the SCF recycle flow 309 using methods well known in the art. The remaining components are identical to those described in the previous embodiment shown in FIG. 3D.

In another embodiment of the present invention and shown in FIG. 3F the pressure exchanger discharge flow 305 is conveyed through the first separation vessel 306 and the extracted compound 307 is separated from the pressure exchanger discharge flow 305 and discharged from the first separation vessel 306. A second extracted compound 316 that may have a higher density or larger molecular size for example and without limitation than the extracted compound 307 is also separated from the pressure exchanger discharge flow 305 and the extracted compound 307. The inclusion of trays, filters and other methods well known in the art may be installed within the first separation vessel 306 to induce the separation between extracted compound 307, second extracted compound 316 and SCF. The remaining components of the pressure exchanger discharge flow 305 which predominantly comprise SCF is discharged from the first separation vessel 306 as first separation vessel discharge 308 and conveyed through pipe to the pressure exchanger 304. The remaining components are identical to those described in the previous embodiment shown in FIG. 3A.

It should be understood that the system shown in FIG. 1A-1G, FIG. 2A-2F FIG. 3A-3G may be implemented in various arrangements, with a plurality of components. It should also be understood that where the terms flow, discharge, convey, conveying, draw, transport, or other means of transmitting gas, liquid, SCF, or solid components are used, the use of a pressure-retaining device, by way of example and not limitation, a pipe, a tube, a box-section, a casting, a forging or other means of retaining pressure between one component to another is also generally included and may be used in various configurations and arrangements. The Term extraction includes gasification, liquefaction or any other means of converting a solid, gaseous or liquid feedstock into another desired or target compound through the use of a SCF. The term pipe is also a generic term used to describe a device that retains internal pressure while transporting substances between components. The term vessel is a generic term for an enclosed area that may be a vessel, a tank, a pipe, a tube, a receptacle, a chamber, a canister, a container, a flask, pipework or another enclosed area known in the art. In addition, the term flow can also be called extraction flow, insoluble flow or other used to describe the pipe or apparatus the specific flow or discharge is travelling through. The term valve can be interchanged with any means of segregating flow and/or different pressures within the system. The term mechanically coupled may also be described as operatively coupled refers to the connection between two components using welding, bolts, fasteners, casting, bonding, forging, or another joining method able to withhold pressure and external loads. The term operatively coupled may also be used to describe an electrical connection that provides a means of transferring power from one device or apparatus to another. The naming of a valve, pipe or other equipment is for exemplary purposes only and used to describe the different steps within the various embodiments of the disclosure, for example one named valve may provide a single function or plurality of functions detailed within the disclosure and does not represent that multiple separate valves must be used to perform each individual function.

It is contemplated that any embodiment discussed in this specification can be implemented with respect to any method of the invention, and vice versa. It will be also understood that particular embodiments described herein are shown by way of illustration and not as limitations of the invention. The principal features of this invention can be employed in various embodiments without departing from the scope of the invention. Those skilled in the art will recognize or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference. Incorporation by reference is limited such that no subject matter is incorporated that is contrary to the explicit disclosure herein, no claims included in the documents are incorporated by reference herein, and any definitions provided in the documents are not incorporated by reference herein unless expressly included herein.

The use of the word “a” or “an”, when used in conjunction with the term “comprising” in the claims and/or the specification, may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step, or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context. As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature.

What is claimed:

1. A method of extracting a compound contained within at least one solid or liquid substrate using a supercritical fluid stream, the method comprises the following steps:
a. providing an extraction vessel at least partially filled with at least one solid or liquid substrate;
b. mixing the supercritical fluid stream with the substrate of step (a) to form an extraction flow;
c. operating a pressure exchanger positioned between the first separation vessel and the extraction vessel, the pressure exchanger is configured to:
i. transfer the extraction flow from the extraction vessel to the first separation vessel where extraction vessel pressure is higher than first separation vessel pressure,
ii. transfer first separation vessel discharge from the first separation vessel to the extraction vessel; where the first separation vessel pressure is lower than the extraction vessel pressure,
d. using the pressure exchanger to change the pressure of the supercritical fluid within the pressure exchanger flow to differ from the extraction compound, thereby causing separation of the extraction compound from the extraction flow within the first separation vessel;
e. directing the supercritical fluid within the first separation vessel discharge from the first separation vessel to the extraction vessel, while retaining the extraction compound in the first separation vessel;
f. repeating steps (a) through (e) until all soluble compound is removed from the extraction flow.

2. The method of claim 1, wherein a compression device is operatively coupled to at least one of the extraction vessel, the first separation vessel.

3. The method as in claim 1, wherein the pressure exchanger comprises a decompression device and compression device, wherein operating the decompression device generates power used to energize the compression device.

4. The method of claim 3, wherein the compression device is operatively coupled to at least one of the extraction vessel, or the first compound separation vessel, or the second compound separation vessel.

5. The method of claim 1, wherein the extraction vessel comprises an outlet with a solid compound screen configured to retain at least some of the insoluble solid compound inside thereof.

6. The method of claim 1, wherein a ejector device is operatively coupled to at least one of the extraction vessel, the pressure exchanger, first separation vessel.

7. The method of claim 1, wherein insoluble separator device is operatively coupled to at least one of the extraction vessel, the pressure exchanger, first separation vessel.

8. The method of claim 1, wherein a valve is operatively coupled to at least an inlet or an outlet of the pressure exchanger to control flow therethrough.

9. A method of extracting a compound contained within at least one solid or liquid substrate using a supercritical fluid stream, the method comprises the following steps:
a. providing an extraction vessel at least partially filled with at least one solid or liquid substrate;
b. mixing the supercritical fluid stream with the substrate of step (a) to form an extraction flow;
c. operating a pressure exchanger positioned between the extraction vessel and first separation vessel and the second pressure exchanger, the pressure exchanger is configured to:
i. transfer the extraction flow from the extraction vessel to the first separation vessel where extraction vessel pressure is higher than first separation vessel pressure,
ii. transfer second pressure exchanger discharge flow to the extraction vessel where the second pressure exchanger discharge flow pressure is lower than the extraction vessel pressure;
d. using the pressure exchanger to change a pressure of the supercritical fluid within the pressure exchanger discharge to differ from the extraction compound, thereby causing separation of the extraction compound from the pressure exchanger discharge within the first separation vessel;
e. directing the supercritical fluid within the first separation vessel discharge from the first separation vessel to the second separation vessel, while retaining the extraction compound in the first separation vessel;
f. operating a second pressure exchanger positioned between the first separation vessel and the second separation vessel, the pressure exchanger is configured to:
i. transfer the first separation vessel discharge flow from the first separation vessel to the second separation vessel where the first separation vessel pressure is higher than second separation vessel pressure,
ii. transfer second separation vessel discharge flow from the second separation vessel to the pressure exchanger, where the second pressure exchanger discharge flow pressure is lower than the pressure exchanger pressure,
g. Using the second pressure exchanger to change a pressure of the supercritical fluid within the first separator discharge flow to differ from the second extraction compound, thereby causing separation of the second extraction compound from the pressure exchanger discharge flow within the second separation vessel;
h. directing the supercritical fluid within the second separation vessel discharge from the second separation vessel to the second separation vessel, while retaining the second extraction compound in the second separation vessel;
i. repeating steps (a) through (h) until all extraction and second extraction compound is removed from the extraction flow.

10. The method of claim 9, wherein a compression device is operatively coupled to at least one of the extraction vessel, the first separation vessel or the second separation vessel.

11. The method of claim 9, wherein a valve is operatively coupled to at least an inlet or an outlet of the pressure exchanger to control flow therethrough.

12. The method as in claim 9, wherein the pressure exchanger comprises a decompression device and compression device, wherein operating the decompression device generates power used to energize the compression device.

13. The method of claim 12, wherein the compression device is operatively coupled to at least one of the extraction vessel, or the first compound separation vessel, or the second compound separation vessel.

14. The method of claim 9, wherein the extraction vessel comprises an outlet with a solid compound screen configured to retain at least some of the insoluble solid compound inside thereof.

15. The method of claim 9, wherein a ejector device is operatively coupled to at least one of the extraction vessel, the pressure exchanger, first separation vessel or the second compound separation vessel.

16. The method of claim 9, wherein insoluble separator device is operatively coupled to at least one of the extraction vessel, the pressure exchanger, first separation vessel or the second compound separation vessel.
